(19) United States
(12) Patent Application Publication
(10) Pub. No.: US 2025/0278462 A1
(43) Pub. Date: Sep. 4, 2025

(54) COMPUTER-READABLE STORAGE MEDIUM AND METHOD FOR USING SPECIFIC PROGRAM ON INFORMATION PROCESSING DEVICE WHEN INFORMATION PROCESSING DEVICE IS CONNECTED WITH IMAGE PROCESSING DEVICE

(71) Applicant: BROTHER KOGYO KABUSHIKI KAISHA, Nagoya (JP)

(72) Inventor: Junya Asano, Gifu (JP)

(21) Appl. No.: 19/044,893

(22) Filed: Feb. 4, 2025

(30) Foreign Application Priority Data
Feb. 29, 2024 (JP) 2024-029658

(51) Int. Cl. G06F 21/12; G06F 3/12; G06F 8/61

(52) U.S. Cl. CPC G06F 21/121; G06F 3/1203; G06F 3/123; G06F 3/1259; G06F 8/61

(57) ABSTRACT

A non-transitory computer-readable storage medium stores computer-readable instructions executable by a computer of an information processing device. The instructions include a program set configured to be downloaded from a first server by an operating system of the information processing device in response to the information processing device being communicably connected with an image processing device. The program set includes a first program of a first type, a second program of a second type different from the first type, and a third program of the second type. The first program, in response to being launched by the operating system in a case where the program set has been downloaded to the information processing device, causes the computer to launch the second program that does not require user account control. The second program causes the computer to launch the third program requiring the user account control in response to being launched.

### REFERENCE TO RELATED APPLICATIONS

This application claims priority from Japanese Patent Application No. 2024-029658 filed on Feb. 29, 2024. The entire content of the priority application is incorporated herein by reference.

### BACKGROUND ART

Heretofore, a technology has been known in which, in response to an image processing device such as a printer being connected with an information processing device such as a personal computer (hereinafter referred to as a “PC”), a program to control the image processing device is automatically installed on the information processing device. For instance, a configuration for the information processing device has been disclosed in which a device application is automatically downloaded to the information processing device when an operating system (hereinafter referred to as an “OS”) of the information processing device has detected a printer by plug-and-play and automatic installation control information indicates automatic downloading.

### SUMMARY

A new technology is desired to enable the information processing device to use programs related to the image processing device when the information processing device is communicably connected with the image processing device.

According to aspects of the present disclosure, a non-transitory computer-readable storage medium is provided, which stores computer-readable instructions that are executable by a computer of an information processing device. The computer-readable instructions include a program set configured to be downloaded from a first server by an operating system of the information processing device in response to the information processing device being communicably connected with an image processing device via a communication interface of the information processing device. The program set includes a first program, a second program, and a third program. The first program is of a first type. The second program and the third program are of a second type different from the first type. The first program is configured to be launched by the operating system in a case where the program set has been downloaded from the first server to the information processing device. The first program is further configured to, in response to being launched by the operating system, cause the computer to launch the second program that does not require user account control. The second program is configured to, in response to being launched by the first program, cause the computer to launch the third program that requires the user account control.

According to aspects of the present disclosure, further provided is a non-transitory computer-readable storage medium storing computer-readable instructions that are executable by a computer of an information processing device. The computer-readable instructions include a program set configured to be downloaded from a first server by an operating system of the information processing device in response to the information processing device being communicably connected with an image processing device via a communication interface of the information processing device. The program set includes a first type program, and a second type program different from the first type program. The first type program is configured to be launched by the operating system in a case where the program set has been downloaded from the first server to the information processing device. The first type program is further configured to, in response to being launched by the operating system, cause the computer to perform a launch process to launch the second type program. The second type program is configured to, in response to being launched by the first type program, cause the computer to receive a selection of whether to install one or more control programs for controlling the image processing device, and perform an installation process to install the one or more control programs in response to receiving a selection of installing the one or more control programs.

According to aspects of the present disclosure, further provided is a method implementable by a computer of an information processing device using a program set. The program set is downloaded from a first server by an operating system of the information processing device in response to the information processing device being communicably connected with an image processing device via a communication interface of the information processing device. The program set includes a first launcher program, a second launcher program, and a specific program that are executable by the computer. The first launcher program is of a first type. The second launcher program and the specific program are of a second type different from the first type. The method includes launching, by the first launcher program, the second launcher program that does not require user account control, in response to the first launcher program being launched by the operating system in a case where the program set has been downloaded from the first server to the information processing device. The method further includes launching, by the second launcher program, the specific program that requires the user account control, in a case where the second launcher program has been launched by the first launcher program.

### BRIEF DESCRIPTION OF DRAWINGS

FIG. 1 is a block diagram schematically showing an electrical configuration of a personal computer (hereinafter referred to as a “PC”) connected with a printer, a first server, and a second server.

FIG. 2 is a sequence diagram showing an example of processes and operations by individual programs.

FIG. 3 shows an example of a pop-up screen.

FIG. 4 shows an example of an administrator privilege approval screen.

FIG. 5 is a sequence diagram showing an example of operations to install one or more control programs.

FIG. 6 shows an example of a selection screen.

FIG. 7 is a sequence diagram showing an example of processes and operations by individual programs.

### DESCRIPTION

It is noted that various connections are set forth between elements in the following description. It is noted that these connections in general and, unless specified otherwise, may be direct or indirect and that this specification is not intended to be limiting in this respect. Aspects of the present disclosure may be implemented on circuits (such as application specific integrated circuits) or in computer software as programs storable on computer-readable media including but not limited to RAMs, ROMs, flash memories, EEPROMs, CD-media, DVD-media, temporary storage, hard disk drives, floppy drives, permanent storage, and the like.

In the present disclosure, an inclusive OR, meaning that it includes either A or B or both, may be expressed as “A and/or B,” “at least one of A or B,” or “at least one selected from the group consisting of A and B.” The same applies to a case where there are three or more selectable elements to consider.

### First Illustrative Embodiment

A PC (“PC” is an abbreviation for “Personal Computer”) 1 in a first illustrative embodiment according to aspects of the present disclosure is connectable with a printer 2 having a printing function of printing images. The PC 1 is configured to, when various application programs (hereinafter referred to as “applications”) for causing the printer 2 to perform processing (e.g., printing) using functions of the printer 2 are installed thereon, perform specific processing with the applications. The PC 1 may be an example of an “information processing device” according to aspects of the present disclosure. Nonetheless, examples of the “information processing device” are not limited to the PC 1, but may include a smartphone and a tablet computer. Namely, a smartphone or a tablet computer may be used instead of the PC 1.

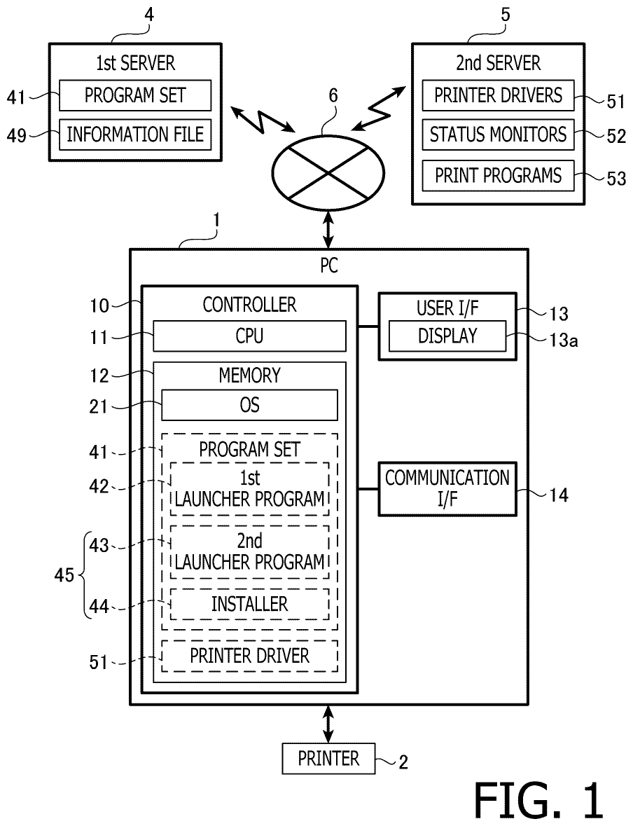

As shown in FIG. 1, the PC 1 of the first illustrative embodiment has a controller 10 that includes a CPU 11 and a memory 12. The PC 1 further includes a user interface (hereinafter referred to as a “user I/F”) 13 and a communication interface (hereinafter referred to as a “communication I/F”) 14, which are electrically connected with the controller 10. The “controller 10” in FIG. 1 is a collective term for hardware and software used to control the PC 1, and may not necessarily represent a single hardware element actually existing in the PC 1.

The CPU 11 of the PC 1 is configured to perform various processes according to programs read from the memory 12 and based on user operations. The memory 12 stores various types of data and various programs. The memory 12 is also used as a work area when various processes are performed. A buffer provided to the CPU 11 may be an example of a “memory” according to aspects of the present disclosure. Examples of the memory 12 are not limited to a ROM, a RAM, and an HDD that are incorporated in the PC 1, but may include storage media (e.g., CD-ROMs and DVD-ROMs) that are readable and writable by the CPU 11.

The user I/F 13 includes a display 13a that is hardware configured to display screens to provide information to the user, and hardware configured to receive user operations. The user I/F 13 may have a combination of the display 13a configured to display information (i.e., having a display function), and a mouse and/or a keyboard that are configured to receive user input operations (i.e., having an input reception function). The user I/F 13 may include a touch panel having the display function of the display 13a and the input reception function.

The communication I/F 14 includes hardware configured to communicate with external devices such as a first server 4, a second server 5, and the printer 2. Communication standards applicable for the communication I/F 14 include Ethernet (“Ethernet” is a registered trademark of Fuji Xerox Co., Ltd.), Wi-Fi (“Wi-Fi” is a registered trademark of the non-profit Wi-Fi Alliance), and USB. The PC 1 may be configured to connect with the Internet via the communication I/F 14. The PC 1 may have a plurality of communication I/Fs 14 conforming to a plurality of communication standards.

An operating system (hereinafter referred to as an “OS”) 21 is incorporated in the memory 12 of the PC 1. The OS 21 is a multitasking operating system configured to handle a plurality of tasks in parallel by managing the plurality of tasks and switching between/among the plurality of tasks. Examples of the OS 21 may include, but are not limited to, Windows (“Windows” is a registered trademark of Microsoft Corporation), macOS (“macOS” is a registered trademark of Apple Inc.), Linux (“Linux” is a registered trademark of Linus Torvalds), iOS (“iOS” is a registered trademark of Cisco Systems, Inc.), and Android (“Android” is a registered trademark of Google LLC).

The memory 12 is configured to store programs downloaded from the first server 4 and the second server 5. For instance, the PC 1 is enabled to download from the first server 4 a program set 41 for installing control programs compatible with the printer 2 and to download from the second server 5 a printer driver 51 configured to control printing by the printer 2, thereby storing the program set 41 and the printer driver 51 in the memory 12.

The second server 5 in the first illustrative embodiment is a server provided by a printer vendor. The second server 5 stores control programs for controlling printers. The second server 5 is a web server configured to make the control programs available to information processing devices such as the PC 1 and provide the control programs in response to requests from the information processing devices.

For instance, the control programs include the printer driver 51, a status monitor 52, and a print program 53. For instance, the printer driver 51 is configured to generate print data for causing the printer 2 to perform printing in cooperation with the OS 21. For instance, the printer driver 51 is further configured to connect an information processing device such as the PC 1 with a printer and to control printing by the printer. The status monitor 52 is configured to monitor a status of the printer 2. For instance, the print program 53 is configured to receive a print instruction to cause a printer (e.g., the printer 2) to perform printing. The print program 53 may be configured to create and/or edit an image to be printed.

The first server 4 in the first illustrative embodiment is a server provided by a vendor of the OS 21. The first server 4 stores programs that are executable by the OS 21. For instance, the first server 4 is configured to manage programs uploaded by various vendors. The first server 4 is further configured to make programs available to information processing devices such as the PC 1 and to provide the programs in response to requests from the information processing devices. For instance, the first server 4 is a cloud server configured to provide services of online store(s) (such as so-called Microsoft Store) provided by Microsoft Corporation. The programs stored in the first server 4 may include a stand-alone program and/or a program set including a plurality of programs.

In the first illustrative embodiment, the program set 41 and an information file 49 are stored on the first server 4. The program set 41 and the information file 49 are uploaded to the first server 4 by a vendor of the printer 2. The information file 49 contains information that associates a hardware ID and the program set 41 with each other. For instance, the information file 49 is an INF file (i.e., a setup information file). The hardware ID is identification information defined by the vendor of the printer 2.

The first server 4 may include a plurality of servers. In this case, one of the plurality of servers may manage the information file 49, and may provide the information file 49 in response to a request from the PC 1. Further, in this case, another server may manage the program set 41, and may provide the program set 41 in response to a request from the PC 1.

The program set 41 in the first illustrative embodiment includes a first launcher program 42, a second launcher program 43, and an installer 44. The first launcher program 42 is a program for a particular setup environment. For instance, the particular setup environment is an environment in which a program is automatically downloaded from the first server 4 to the PC 1 and set up in response to the PC 1 being communicably connected with a device such as the printer 2. For instance, the first launcher program 42 is a UWP application compliant with the Universal Windows Platform (hereinafter referred to as “UWP”), which is an implementation platform for software running on Microsoft's Windows (“Windows” is a registered trademark of Microsoft Corporation) 10. UWP applications are automatically downloaded to the PC 1 from the Microsoft Store in response to the PC 1 being communicably connected with a device such as the printer 2, but are unable to launch Win32 applications that require user account control.

The second launcher program 43 and the installer 44 are programs that do not correspond to the particular setup environment and are different in type from the first launcher program 42. For instance, the second launcher program 43 and installer 44 are Win32 applications. The second launcher program 43 and installer 44 are programs configured to be downloaded from the first server 4 along with a UWP application, as part of the program set 41, and to be launched by the UWP application. In the second illustrative embodiment, second type programs 45 include the second launcher program 43 and the installer 44. The program set may be referred to as a “program package.”

The installer 44 is a program for installing the control programs such as the printer driver 51, the status monitor 52, and the print program 53 on the PC 1. The installer 44 may install all or some of the control programs compatible with the printer 2. The installer 44 may be configured to select one or more installation targets from among the control programs compatible with the printer 2. The installer 44 is a program that requires user account control in order to perform processing with administrator privileges.

The first launcher program 42 in the first illustrative embodiment does not launch programs that require user account control, for security protection. Therefore, the first launcher program 42 is unable to directly launch the installer 44 that requires user account control. Thus, the program set 41 includes the second launcher program 43 configured to be launched by the first launcher program 42 without requiring user account control and to launch the installer 44 with the designation of user account control.

The first launcher program 42 may be an example of a “first type program” according to aspects of the present disclosure, and may be an example of a “first program” according to aspects of the present disclosure. The second launcher program 43 may be an example of a “second program” according to aspects of the present disclosure, and may be an example of a “startup program” according to aspects of the present disclosure. The installer 44 may be an example of a “third program” according to aspects of the present disclosure, and may be an example of an “installation program” according to aspects of the present disclosure. The “first type program” may be a PSA (“PSA” is an abbreviation for “Print Support Application”) or an HSA (“HSA” is an abbreviation for “Hardware Support Application”) instead of a normal UWP application.

The PC 1 in the first illustrative embodiment is connected with the printer 2 via the communication I/F 14. The printer 2 has at least the printing function and a communication function. The printer 2 is configured to, for instance, in response to receiving print data from the PC 1, perform printing based on the received print data. The printer 2 may be configured to perform color printing, or to perform only single-color printing.

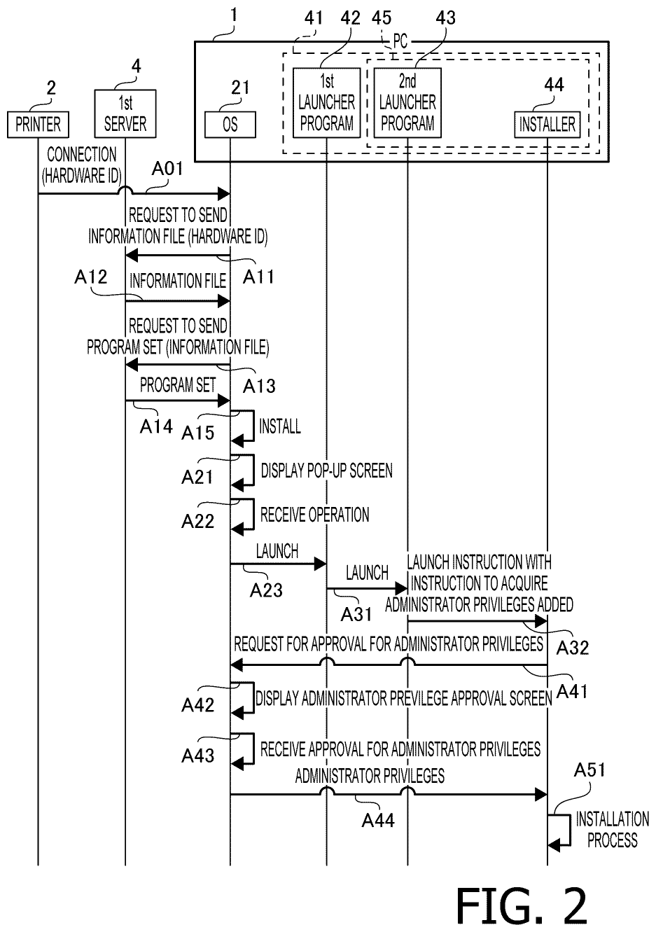

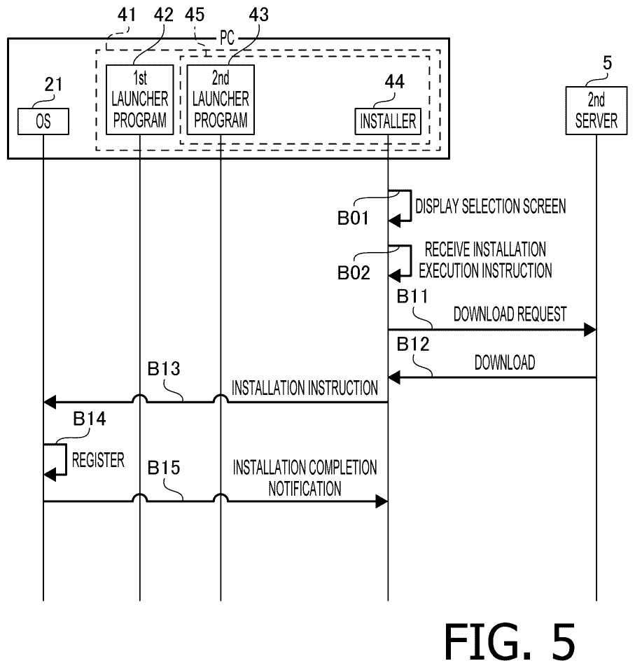

Subsequently, a procedure of a process in which the PC 1 in the first illustrative embodiment performs a setup with the program set 41 will be described with reference to sequence diagrams shown in FIGS. 2 and 5. Each process other than user operations in the first illustrative embodiment basically indicates processing by the CPU 11 in accordance with instructions described in the programs such as the first launcher program 42, the second launcher program 43, and the installer 44. In the present disclosure, with respect to various processes performed by the controller 10 or the CPU 11 in accordance with the programs such as the first launcher program 42, the second launcher program 43, the installer 44, and the OS 21, an explanation may be provided as if each of the programs performs a corresponding one of the various processes as a main entity responsible for the corresponding process for the sake of explanatory convenience. The processing by the CPU 11 includes hardware control using an API (“API” is an abbreviation for “Application Programming Interface”) of the OS 21. In the present disclosure, operations and processes by the individual programs may be described without a detailed explanation of the OS 21. It is noted that “acquiring” and “acquiring” may be used as concepts that do not necessarily require a request.

As shown in FIG. 2, in response to detecting that the printer 2 is connected with the PC1 via the communication I/F14, the OS 21 of the PC 1 acquires a hardware ID from the printer 2 (A01). If the acquired hardware ID is the first acquired hardware ID, the OS 21 accesses the first server 4 via the communication I/F 14 and sends a request to send the information file 49 (A11). The request includes the hardware ID acquired from the printer 2.

The first server 4 reads the information file 49 corresponding to the hardware ID added to the request and sends the read information file 49 to the PC 1 (A12). In response to receiving the information file 49 via the communication I/F 14, the OS 21 sends a request to send the program set 41 to the first server 4 via the communication I/F 14 (A13). This request includes the information file 49 received in A12. The first server 4 reads the program set 41 that is associated with the hardware ID in the information file 49 added to the request received in A13, and sends the program set 41 to the PC 1 (A14). The OS 21 stores the program set 41 downloaded from the first server 4 via the communication I/F 14 in the memory 12 (A15). Thus, the program set 41 is automatically installed by the OS 21 in response to the printer 2 being connected with the PC 1 for the first time.

After the installation of the program set 41 is completed, the OS 21 causes the display 13 of the user I/F 13 to display a pop-up screen (A21). Namely, the PC 1 displays the pop-up screen on the display 13a to notify the user of the existence of the program set 41 that has been automatically installed in response to the printer 2 being connected with the PC 1.

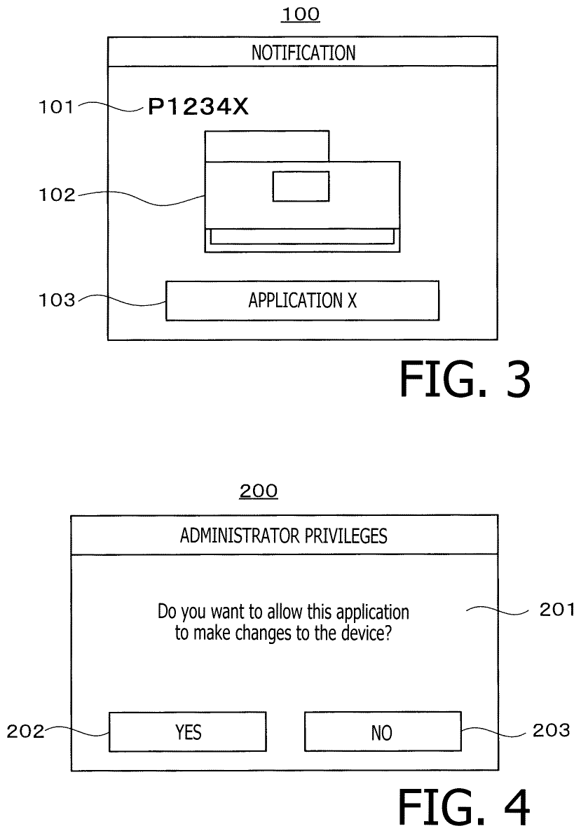

For instance, as shown in an example of a popup screen 100 in FIG. 3, the popup screen 100 displays thereon a model name 101 of the printer 2 connected with the PC 1 and an image showing the appearance of the printer 2. Further, the popup screen 100 includes an icon 103 indicating the existence of the launcher application, i.e., the program set 41. Thus, the PC 1 is enabled to inform the user of the existence of the launcher application compatible with the printer 2 that is communicably connected with the PC 1, i.e., the existence of the program set 41 for launching the installer 44 compatible with the printer 2, and to prompt the user to launch the launcher application, from the pop-up screen 100. The OS 21 waits until the icon 103 is operated.

In response to receiving an operation on the icon 103 via the user I/F 13 (A22), the OS 21 launches the first launcher program 42 corresponding to OS 21 among the programs included in the program set 41 (A23). The first launcher program 42 is registered in the program set 41 as an application to be first launched by the OS 21 among the programs included in the program set 41.

The first launcher program 42 is unable to launch the installer 44 that requires user account control, due to restrictions of the OS 21. Namely, the first launcher program 42 is unable to launch another program by a launch instruction to launch said another program to which an instruction to acquire administrator privileges is added. Therefore, the second launcher program 43, which does not require user account control, is registered in the first launcher program 42 as a target program to be launched. Thus, in response to being launched by the OS 21, the first launcher program 42 launches the second launcher program 43 (A31).

The installer 44, which requires user account control, is registered in the second launcher program 43 as a target program to be launched. In response to being launched by the first launcher program 42, the second launcher program 43 provides the installer 44 with a launch instruction to launch the installer 44, to which an instruction to acquire administrator privileges is added, thereby launching the installer 44 (A32).

In response to the instruction to acquire administrator privileges from the second launcher program 43, the installer 44 sends a request for approval for administrator privileges to the OS 21 (A41). In response to the request from the installer 44, the OS 21 causes the display 13a of the user I/F 13 to display an administrator privilege approval screen (A42). For instance, as shown in an example of an administrator privilege approval screen 200 in FIG. 4, the administrator privilege approval screen 200 includes a message 201 for asking the user whether to allow the installer 44 to make changes to the PC 1, a “Yes” button 202 for allowing the installer 44 to make changes to the PC 1, and a “No” button 203 for not allowing the installer 44 to make changes to the PC 1.

The administrator privilege approval screen 200 may be displayed by a vendor providing the first server 4, which is an issuer of the installer 44, i.e., a download source for the program set 41. The administrator privilege approval screen 200 may include a detail button for displaying details of the changes to be made to the PC 1. In other words, the administrator privilege approval screen 200 may be configured to display materials for the user to determine whether to allow the installer 44 to make changes to the PC 1.

When the “Yes” button 202 included in the administrator privilege approval screen 200 has been operated via the user I/F 13, and the OS 21 has received the approval for administrator privileges as shown in FIG. 2 (A43), the OS 21 passes the administrator privileges to the installer 44 (A44).

In response to acquiring the administrator privileges from the OS 21 (A44), the installer 44 operates with the acquired administrator privileges and performs an installation process to install control programs (A51). Namely, the PC 1 is enabled to automatically install the installer 44 without requiring the user to operate the installer 44 when the PC 1 is communicably connected with the printer 2 for the first time. The PC 1 causes the installer 44 to perform the installation process in a state with the administrator privileges acquired from the OS 21.

The OS 21 does not pass the administrator privileges to the installer 44 until the “No” button 203 is operated on the administrator privilege approval screen 200, or the “Yes” button 202 is operated. In this case, the installer 44 is unable to operate with the administrator privileges, and therefore does not perform the installation process in A51.

The installation process is described with reference to FIG. 5.

For instance, with respect to UWP applications, the user is unable to select whether to install individual control programs on the PC 1, since programs stored in the Microsoft Store are automatically downloaded and installed on the PC 1. Therefore, for instance, by storing a plurality of control programs in the Microsoft Store, it is possible to install all of the control programs on the PC 1 in response to the PC 1 being communicably connected with the printer 2. However, in this case, even control program(s) that are unnecessary for the user may be automatically installed on the PC 1, which raises the concern that the load on the memory 12 may increase.

Therefore, the installer 44, automatically installed on the PC 1 in response to the PC 1 being communicably connected with the printer 2, causes the display 13a of the user I/F 13 to display a selection screen for selectively installing control programs (B01).

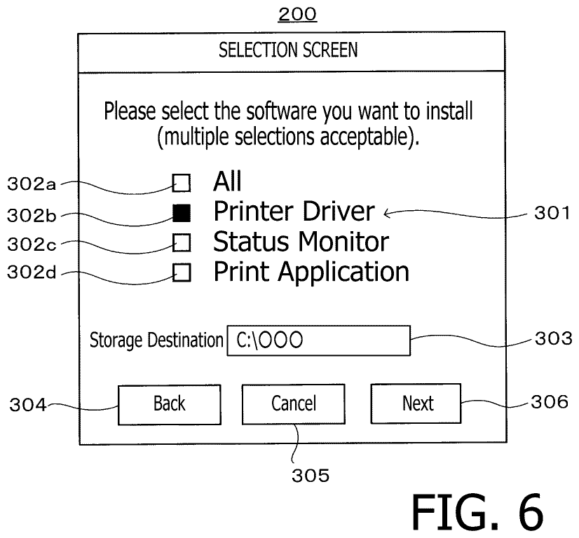

For instance, as shown in an example of a selection screen 300 in FIG. 6, the selection screen 300 displays thereon available choices 301 for control programs that are compatible with the printer 2 and installable on the PC 1. The choices 301 may include an item “All” for selecting all control programs. The choices 301 may include items to show individual control programs, such as “Printer Driver,” “Status Monitor,” and “Print Application.” The status monitor and the print application to be supplied by the second server 5 are Win32 applications. The printer driver is also a Win32 application. The selection screen 300 includes check boxes 302a, 302b, 302c, and 302d to indicate whether each of the items is selected. Selectable control programs to be displayed as available choices on the selection screen 300 may be different from the examples shown in FIG. 6. The selection screen 300 includes a designation field 303 for specifying a storage destination for the control program(s) to be installed. The selection screen 300 includes a “Back” button 304 for returning to the previous process, a “Cancel” button 305 for canceling the installation process, and a “Next” button 306 for confirming the selection. The installer 44 has URL information stored in association with each of the choices 301. The URL information associated with each of the choices 301 indicates a location of the corresponding control program.

The selection screen 300 may include one or more selectable items and one or more non-selectable items. For instance, the printer driver required to control the printer 2 may be a non-selectable control program. In this case, the printer driver must be installed on the PC 1. Meanwhile, the status monitor and the print application may be selectable control programs. In this case, the status monitor and the print application are installed on the PC 1 only when selected.

For instance, when the “Next” button 306 is operated via the user I/F 13 with the check box 302b for “Printer Driver” checked, the installer 44 accesses the second server 5 via the communication I/F 14 based on the URL information associated with the selected printer driver, as shown in FIG. 5, and sends a download request to download the selected printer driver to the second server 5 (B11).

The second server 5 sends the printer driver 51 to the PC 1 that sent the download request (B12). In response to receiving the printer driver 51 via the communication I/F 14, the installer 44 provides the OS 21 with an installation instruction to install the printer driver 51 (B13). This installation instruction includes the downloaded printer driver 51 and information on the storage destination specified in the designation field 303 on the selection screen 300. The OS 21 registers the printer driver 51 selected on the selection screen 300 in the specified storage destination (B14). After the installation of the printer driver 51 is completed in the manner described above, the OS 21 provides an installation completion notification that the installation of the printer driver 51 has been completed to the installer 44 (B15).

A plurality of target programs to be installed may be selected on the selection screen 300. For instance, when the check box 302a is checked, the installer 44 may provide the OS 21 with an installation instruction and the URL information, as added to the installation instruction, of all the control programs compatible with the printer 2. Based on each piece of the URL information, the OS 21 may download all of the selected control programs from the second server 5 and store the downloaded control programs.

The installer 44 does not perform the installation process if the “Back” button 304 or the “Cancel” button 305 is operated. Therefore, the installer 44 is enabled to receive a selection not to install control programs. Thereby, it is possible to suppress the installation of unnecessary control programs on the PC 1 and to suppress the increase in the load on the memory 12 in the PC 1

Thus, the installer 44 is configured to select whether to install the control programs, even after the installer 44 is automatically downloaded to the PC 1 as part of the program set 41 in response to the PC 1 being communicably connected with the printer 2 for the first time. The installer 44 is further configured to allow the user to select one or more programs to be installed from among the plurality of control programs compatible with the printer 2. Thus, since only the control programs required by the user are installed on the PC 1, it is possible to achieve a higher degree of processing freedom for the control programs to be installed. In addition, it is possible to prevent a control program with large data capacity from being automatically installed on the PC 1, thereby suppressing the increase in the load on the memory 12 in the PC 1.

As described above, the program set 41 in the first illustrative embodiment is downloaded to the PC 1 by the OS 21 of the PC 1 in response to the PC 1 being communicably connected with the printer 2. In the program set 41, the first launcher program 42, as first launched by the OS 21, once launches the second launcher program 43 that does not require user account control, and then the second launcher program 43 launches the installer 44 that requires user account control. Thereby, the PC 1 is enabled to launch the installer 44 that requires user account control via the second launcher program 43 even in an environment where the first launcher program 42 is unable to launch the installer 44 that requires user account control. Thus, for instance, the installer 44 is enabled to acquire administrator privileges and perform processing with the acquired administrator privileges.

For instance, UWP applications (which may be included in examples of the “first type program” according to aspects of the present disclosure) compliant with UWP (which may be an example of the “particular setup environment” according to aspects of the present disclosure) are automatically installed from the Microsoft Store, but are unable to launch Win32 applications (which may be included in examples of the “second type program” according to aspects of the present disclosure) that require user account control. An installer that is configured to install various control programs (e.g., a print application and a status monitor) compatible with an image processing device, is a Win32 application, and requires user account control to perform processing with administrator privileges. Therefore, in order to use a system that uses UWP and to launch an installer with user account control, it is required to prepare in the Microsoft Store a program set that includes a UWP application, a launcher application that is a Win32 application, and the installer that is a Win32 application, to cause the first launched UWP application to launch the launcher application that is a Win32 application, and to cause the launcher application that is a Win32 application to launch the installer that is a Win32 application. Thereby, it is possible for the installer to acquire administrator privileges and install various applications with the acquired administrator privileges.

Therefore, the program set 41 in the first illustrative embodiment includes the first launcher program 42 compliant with UWP, and the second launcher program 43 and the installer 44 that correspond to Win32 applications. In addition, in the program set 41, the first launcher program 42 is configured to, after first launched by the OS 21, launch the second launcher program 43 that does not require user account control. Further, the second launcher program 43 is configured to launch the installer 44 that requires user account control. Thus, it is possible to launch the installer 44 that requires user account control in response to the PC 1 being communicably connected with the printer 2 and, for instance, to cause the installer 44 to install control programs compatible with the printer 2 on the PC 1, thereby making the installed control programs available.

Further, in the program set 41 of the first illustrative embodiment, the control programs such as the printer driver 51 are not automatically installed by the OS 21 of the PC 1 in response to the PC 1 being communicably connected with the printer 2, but the program set 41 is once downloaded to the PC 1. In the program set 41, the first launcher program 41 as first launched by the OS 21 launches the installer 44 via the second launcher program 43. In the processing by the installer 44, the PC 1 receives the selection of whether to install each control program compatible with the printer 2 connected with the PC 1, and installs one or more control programs selected as control programs to be installed. Thus, the PC 1 is enabled to install one or more control programs selected by the user even when the PC 1 is connected with the printer 2.

For instance, in UWP, the programs stored in the Microsoft Store are automatically installed, and therefore the user is not allowed to select whether to install the individual programs. Hence, for instance, by storing a plurality of control programs in the Microsoft Store, it is possible to install all the control programs installed on the PC 1 in response to the PC 1 being connected with the printer 2. However, in this case, even unnecessary control program(s) may be automatically installed on the PC 1, which raises the concern that the load on the memory 12 may increase.

Therefore, the program set 41 in the first illustrative embodiment is configured to cause the OS21 to install the installer 44 for the control programs, and to use the installer 44 to selectively install the control programs. Thus, it is anticipated that the increase in the load on the memory 12 will be suppressed.

### Second Illustrative Embodiment

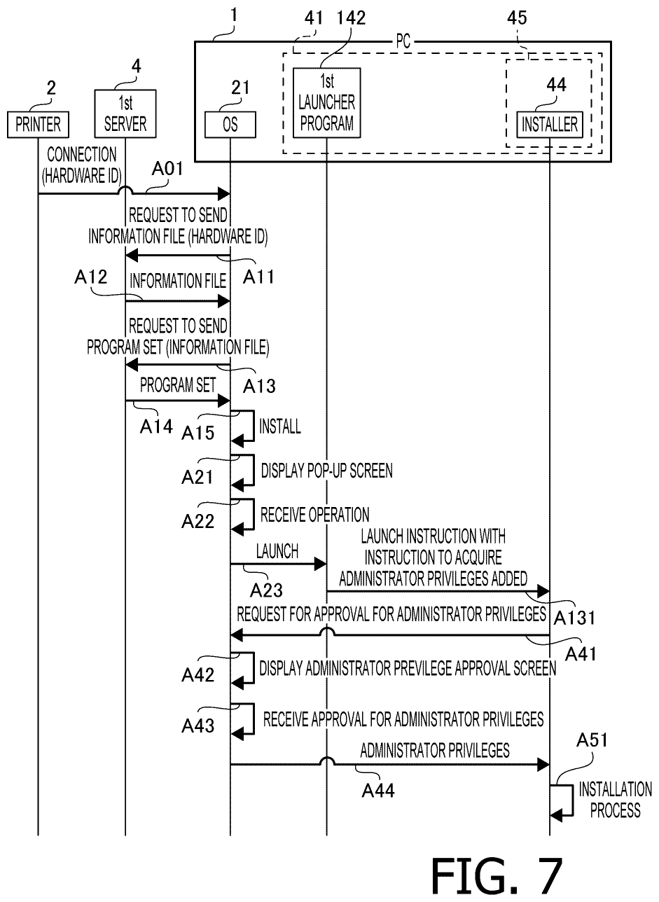

Subsequently, a program set in a second illustrative embodiment according to aspects of the present disclosure is described below with reference to the relevant drawings. As shown in FIG. 7, in a program set 141 of the second illustrative embodiment, the second type program(s) 45 includes only the installer 44. In this respect, the second illustrative embodiment differs from the aforementioned first illustrative embodiment in which the second type programs 45 include the second launcher program 43 and the installer 44. Here, an explanation will be provided focusing on different features from the first illustrative embodiment. For substantially the same configurations as in the first illustrative embodiment, the same reference characters will be used to represent them, and explanations thereof may be omitted as appropriate.

The program set 141 includes a first launcher program 142 and the installer 44. The first launcher program 142 is provided by the OS 21 and configured to launch programs that require user account control. The first launcher program 142 differs in this respect from the first launcher program 42 of the aforementioned first illustrative embodiment that is unable to launch programs that require user account control. Thus, since the first launcher program 142 is enabled to launch the installer 44 that requires user account control, the program set 141 does not include the second launcher program 43.

The first launcher program 142 of the program set 141 is launched by the OS 21 in response to the PC 1 being communicably connected with the printer 2 via the communication I/F 14 (A01, A11-A15, A21-A23). The first launcher program 142 is registered in the program set 141 as an application to be first launched by the OS 21.

The first launcher program 142 is enabled to launch programs that require user account control. The installer 44 is registered in the first launcher program 142 as a target program to be launched. Therefore, the first launcher program 142 provides the installer 44 with a launch instruction to launch the installer 44, to which an instruction to acquire administrator privileges is added, thereby launching the installer 44 without using the second launcher program 43 in the aforementioned first illustrative embodiment (A131). The launched installer 44 acquires administrator privileges (A41-A44) and performs the installation process (A51).

The program set 141 in the second illustrative embodiment does not include the second launcher program 43. However, in response to the PC 1 being communicably connected with the printer 2, the first launcher program 142 as first launched by the OS 21 causes the installer 44 to operate with administrator privileges. Further, the PC 1 is configured to, in the processing by the installer 44, receive a selection of whether to install each control program compatible with the printer 2, and to install one or more control programs when the selection of installing the one or more control programs has been received. Thus, the PC 1 is enabled to install the one or more control programs selected by the user even when the PC 1 is connected with the printer 2. Further, since the PC 1 is configured to use the installer 44 to selectively install the control programs, it is anticipated that the increase in the load on the memory 12 will be suppressed.

While aspects of the present disclosure have been described in conjunction with various example structures outlined above and illustrated in the drawings, various alternatives, modifications, variations, improvements, and/or substantial equivalents, whether known or that may be presently unforeseen, may become apparent to those having at least ordinary skill in the art. Accordingly, the example embodiment(s), as set forth above, are intended to be illustrative of the technical concepts according to aspects of the present disclosure, and not limiting the technical concepts. Various changes may be made without departing from the spirit and scope of the technical concepts according to aspects of the present disclosure. Therefore, the disclosure is intended to embrace all known or later developed alternatives, modifications, variations, improvements, and/or substantial equivalents. Some specific examples of potential modifications according to aspects of the present disclosure are provided below.

For instance, practicable examples of the printer 2 may include, but are not limited to, a single-function printing device having only the printing function, and a multi-function peripheral having multiple functions such as a scanning function as well as the printing function. Further, instead of the printer 2, devices (e.g., an image scanner and a camera) having image processing functions may be included in examples of an “image processing device” according to aspects of the present disclosure.

For instance, the process of A15 in FIG. 2 may be omitted. In this case, the OS 21 may display the pop-up screen without storing the downloaded program set 41 in memory 12, i.e., without installing the program set 41.

For instance, the processes of A21 and A22 in FIG. 2 may be omitted. In this case, the OS 21 may not display the pop-up screen in response to the first launcher program 42 being downloaded. However, when the pop-up screen is displayed, it makes it easier for the user to notice the existence of the program set 41 automatically downloaded to the PC 1, thereby facilitating the installation of the control programs.

For instance, the control programs may be incorporated in the installer 44. In this case, the installer 44 does not need to access the second server 5. Therefore, the installer 44 may install the control programs even when the communication between the PC 1 and the second server 5 is offline. However, when the control programs are stored in the second server 5 and are downloaded to the PC1, it is possible to shorten the transfer time for the program set 41 due to the reduced size of the program set 41.

Examples of a “third program” according to aspects of the present disclosure are not limited to the installer 44, but may include programs configured to perform particular processing with administrator privileges. Examples of the programs configured to perform particular processing with administrator privileges may include, but are not limited to, a program having the authority to change security settings of the OS 21, a program configured to change communication settings of the OS 21, and a program having a function to use a particular resident service of the OS 21.

For instance, one or more control programs to be installed may be determined in advance, instead of the installer 44 downloading the control programs from the second server 5 and installing the downloaded control programs on the PC 1. For instance, one or more control programs to be installed may be incorporated in advance in the installer 44, and the installer 44 may install the one or more control programs on the PC 1 without accessing the second server 5. In this case, the processes of B01, B02, B11, and B12 in FIG. 5 may be omitted.

For instance, the processes of B01 and B02 in FIG. 5 may be omitted such that the PC 1 does not receive a selection of whether to install the control programs. For instance, one or more control programs to be downloaded from the second server 5 may be determined in advance, and the installer 44 may access the second server 5 and download the one or more control programs to the PC 1 without receiving the selection of the one or more control programs to be downloaded.

The installer 44 may be configured to not receive a selection of whether to install each control program, but to receive only a selection of whether to perform the control program installation. In this case, the installer 44 may install predetermined control programs on the PC 1 in response to receiving the selection of performing the control program installation. However, when the installer 44 is configured to receive a selection of whether to install each control program on the selection screen 300, it is possible to suppress the increase in the load on the memory 12 due to the automatic installation of unnecessary control programs on the PC 1. In addition, since one or more control programs to be installed are selectable from among a plurality of control programs, it is possible to achieve a higher degree of freedom in installing the one or more control programs.

For instance, the program set 41 may be stored in the first server 4 in direct association with the hardware ID without using the information file 49. In this case, the OS 21 may send a request to send the program set 41 in A11 of FIG. 2 or FIG. 7. The request may have the hardware ID added. The first server 4 may send to the PC 1 the program set 41 associated with the hardware ID added to the request. Then, the OS 21 may install the program set 41 downloaded from the first server 4 (A15). Thereby, the back-and-forth processes between the first server 4 and the OS 21 as shown in A12 and A13 of FIG. 2 or FIG. 7 may be omitted.

In any flowchart disclosed in the aforementioned illustrative embodiments, a plurality of processes in a plurality of any steps may be arbitrarily changed in the execution order thereof or may be executed in parallel as long as there is no inconsistency in the processing results.

The processing disclosed in the aforementioned illustrative embodiments may be performed by one or more CPUs, one or more hardware elements such as ASICs, or a combination of at least two selected therefrom. The processing disclosed in the aforementioned illustrative embodiments may be implemented in various aspects such as a non-transitory computer-readable storage medium storing computer-readable instructions (e.g., programs) for performing the processing, or a method for performing the processing.

The following shows examples of associations between elements illustrated in the aforementioned illustrative embodiment(s) and modification(s), and elements claimed according to aspects of the present disclosure. For instance, the PC 1 may be an example of an “information processing device” according to aspects of the present disclosure. The CPU 11 may be an example of a “computer” according to aspects of the present disclosure. The memory 12 may be an example of a “non-transitory computer-readable storage medium” according to aspects of the present disclosure. The OS 21 may be an example of an “operating system” according to aspects of the present disclosure. The printer 2 may be an example of an “image processing device” according to aspects of the present disclosure. The first server 4 may be an example of a “first server” according to aspects of the present disclosure. The second server 5 may be an example of a “second server” according to aspects of the present disclosure. The program set 41 may be an example of a “program set” according to aspects of the present disclosure. The first launcher program 42 may be an example of a “first program” according to aspects of the present disclosure. The first launcher program 42 may be an example of a “first type program” according to aspects of the present disclosure. The second launcher program 42 may be an example of a “second program” according to aspects of the present disclosure. The second launcher program 42 may be an example of a “launcher program” according to aspects of the present disclosure. The second launcher program 42 may be included in examples of a “second type program” according to aspects of the present disclosure. The installer 44 may be an example of a “third program” according to aspects of the present disclosure. The installer 44 may be an example of an “installer program” according to aspects of the present disclosure. The installer 44 may be an example of a “specific program” according to aspects of the present disclosure. The installer 44 may be included in examples of the “second type program” according to aspects of the present disclosure.

What is claimed is:

1. A non-transitory computer-readable storage medium storing computer-readable instructions that are executable by a computer of an information processing device, the computer-readable instructions comprising a program set configured to be downloaded from a first server by an operating system of the information processing device in response to the information processing device being communicably connected with an image processing device via a communication interface of the information processing device, the program set including a first program, a second program, and a third program, the first program being of a first type, the second program and the third program being of a second type different from the first type,
wherein the first program is configured to:
be launched by the operating system in a case where the program set has been downloaded from the first server to the information processing device; and
in response to being launched by the operating system, cause the computer to launch the second program that does not require user account control, and
wherein the second program is configured to, in response to being launched by the first program, cause the computer to launch the third program that requires the user account control.

2. The non-transitory computer-readable storage medium according to claim 1,
wherein the third program includes an installer for one or more control programs configured to, when executed by the computer, cause the computer to control the image processing device, and
wherein the third program is configured to, in response to being launched by the second program, cause the computer to:
acquire administrator privileges with the user account control; and
perform an installation process to install the one or more control programs in a state with the administrator privileges acquired.

3. The non-transitory computer-readable storage medium according to claim 2,
wherein the third program is further configured to, in response to being launched by the second program, cause the computer to:
in the installation process, receive selection of the one or more control programs to be installed from among a plurality of installable control programs, and install the selected one or more control programs on the information processing device.

4. The non-transitory computer-readable storage medium according to claim 3,
wherein the third program is further configured to, in response to being launched by the second program, cause the computer to:
in the installation process, download the selected one or more control programs from a second server different from the first server, and install the downloaded one or more control programs.

5. A non-transitory computer-readable storage medium storing computer-readable instructions that are executable by a computer of an information processing device, the computer-readable instructions comprising a program set configured to be downloaded from a first server by an operating system of the information processing device in response to the information processing device being communicably connected with an image processing device via a communication interface of the information processing device, the program set including a first type program, and a second type program different from the first type program,
wherein the first type program is configured to:
be launched by the operating system in a case where the program set has been downloaded from the first server to the information processing device; and
in response to being launched by the operating system, cause the computer to perform a launch process to launch the second type program, and
wherein the second type program is configured to, in response to being launched by the first type program, cause the computer to:
receive a selection of whether to install one or more control programs for controlling the image processing device; and
perform an installation process to install the one or more control programs in response to receiving a selection of installing the one or more control programs.

6. The non-transitory computer-readable storage medium according to claim 5,
wherein the second type program includes a launcher program and an installer program,
wherein the first type program is configured to, in response to being launched by the operating system, cause the computer to launch the launcher program that does not require user account control, in the launch process,
wherein the launcher program is configured to, in response to being launched by the first type program, cause the computer to launch the installer program that requires the user account control, and
wherein the installer program is configured to, in response to being launched by the launcher program, cause the computer to acquire administrator privileges with the user account control, and perform the installation process in a state with the administrator privileges acquired.

7. The non-transitory computer-readable storage medium according to claim 5,
wherein the second type program is further configured to, in response to being launched by the first type program, cause the computer to:
in the installation process, receive a selection of whether to install each of a plurality of installable control programs, and install the one or more control programs selected as control programs to be installed from among the plurality of installable control programs.

8. The non-transitory computer-readable storage medium according to claim 7,
wherein the second type program is further configured to, in response to being launched by the first type program, cause the computer to:
in the installation process, download the one or more control programs selected as control programs to be installed from among the plurality of installable control programs, from a second server that is different from the first server and stores the plurality of installable control programs, and install the downloaded one or more control programs on the information processing device.

9. The non-transitory computer-readable storage medium according to claim 5,
wherein the image processing device is a printing device, and
wherein the one or more control programs include a printer driver compatible with the printing device.

10. The non-transitory computer-readable storage medium according to claim 5,
wherein the image processing device is a printing device, and
wherein the one or more control programs include a print program configured to receive a print instruction to cause the printing device to perform printing.

11. The non-transitory computer-readable storage medium according to claim 5,
wherein the image processing device is a printing device, and
wherein the one or more control programs include a status monitor configured to monitor a status of the printing device.

12. A method implementable by a computer of an information processing device using a program set, the program set being downloaded from a first server by an operating system of the information processing device in response to the information processing device being communicably connected with an image processing device via a communication interface of the information processing device, the program set including a first launcher program, a second launcher program, and a specific program that are executable by the computer, the first launcher program being of a first type, the second launcher program and the specific program being of a second type different from the first type, the method comprising:
launching, by the first launcher program, the second launcher program that does not require user account control, in response to the first launcher program being launched by the operating system in a case where the program set has been downloaded from the first server to the information processing device; and
launching, by the second launcher program, the specific program that requires the user account control, in a case where the second launcher program has been launched by the first launcher program.

13. The method according to claim 12, further comprising:
launching, by the operating system, the first launcher program in the case where the program set has been downloaded from the first server to the information processing device; and
launching, by the first launcher program, the second launcher program in a case where the first launcher program has been launched by the operating system.

14. The method according to claim 12, further comprising:
in a case where the specific program has been launched by the second launcher program, performing, by the specific program:
acquiring administrator privileges with the user account control; and
performing an installation process to install one or more control programs in a state with the administrator privileges acquired, the one or more control programs being configured to, when executed by the computer, cause the computer to control the image processing device.

15. The method according to claim 14,
wherein the installation process comprises:
receiving selection of the one or more control programs to be installed from among a plurality of installable control programs; and
installing the selected one or more control programs on the information processing device.

16. The method according to claim 15,
wherein the installation process further comprises:
downloading the selected one or more control programs from a second server different from the first server; and
installing the downloaded one or more control programs on the information processing device.
